(19) United States
(12) Patent Application Publication
(10) Pub. No.: US 2012/0110432 A1
(43) Pub. Date: May 3, 2012

(54) Tool for Automated Online Blog Generation

(75) Inventors: Tao Mei, Beijing (CN); Xian-Sheng Hua, Beijing (CN); Shipeng Li, Palo Alto, CA (US)

(73) Assignee: Microsoft Corporation, Redmond, WA (US)

(21) Appl. No.: 12/916,331

(22) Filed: Oct. 29, 2010

(51) Int. Cl. G06F 17/00

(52) U.S. Cl. 715/233

(57) ABSTRACT

Techniques for the design and operation of a blogging tool for automated blog creation and automated upload to a server are described herein. A content capturing process may obtain a plurality of images, including still images or video, as well as audio capture of voices and other sound, according to direction of a user operating an image-capture device. One or more of the images may be annotated with metadata or with text, which may be derived from verbal content provided by the user. A template may be selected in either an automated or user-controlled manner. The images and other content may be assembled into the template to form a blog entry. The blog entry may be uploaded to a server or otherwise shared. In one example, the uploading may be in response to a single user command, obtained by operation of a physical user interface or from verbal user input.

### BACKGROUND

Blogging—the act of posting information to a weblog or blog—is growing in popularity. The unusual name, blog, was derived from the last four letters of the word weblog, which is log or chronicle maintained on the web or Internet. Blogs allow people to share their news, thoughts, photos and other content. However, starting and maintaining a blog is a somewhat technical task, which may be above the capability of many people, particularly those who do not have sufficient time to devote to the project. Accordingly, while blogging has grown rapidly in popularity, its growth is limited by the somewhat technical nature of blog design and blog entry preparation.

### SUMMARY

Techniques for the design and operation of a blogging tool for automated blog creation and upload to a server are described herein. The techniques describe the automated assembly of images and other content into an appropriate template. Additional techniques describe a simplified interface that allows the user to upload a blog entry to a server, such as by operation of a single button or verbal command.

An image capturing process may obtain a plurality of images according to direction of a user, who may operate an image-capture device. The images may be annotated with metadata or with a legend of text derived from verbal content provided by the user. A template may be selected in either an automated or user-controlled manner. In one example, a current template is evaluated in an iterative manner, such as after capture of each of the plurality of images. Each evaluation provides an indication of whether a different template, such as from a template library, might provide a better fit to the plurality of images. If indicated, a different template is selected, which replaces the previous template. The template may be assembled to include the plurality of images, the metadata and the text, to thereby create a blog entry. The blog entry may be uploaded to append onto a blog hosted by a server. In one example, the uploading may be triggered in response to a single command, or a simple sequence of commands, from the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a diagram illustrating an example of a functional architecture and techniques describing a blogging tool that assembles multimedia content within a template and uploads a blog entry in an automated manner.

FIG. 2 is a block diagram showing a further example of a functional architecture and techniques describing a blogging tool that assembles multimedia content within a template and uploads a blog entry in an automated manner.

FIG. 3 is an example of a user interface of an automated blogging tool, showing among other things, a part of the user interface that governs selection and use of templates to provide structure to a blog entry.

FIG. 4 is a further example of the user interface, particularly showing an example of selection of a region within a template within which to locate an image or other content during creation of a blog entry.

FIG. 5 is a further example of the user interface, particularly showing an example of how content, such as an image or text, may be characterized according to one or more categories that will assist an algorithm in associating the content with an appropriate region within a template.

FIGS. 6A and 6B show a flow diagram, extending over the two drawing sheets, illustrating an example process for providing a blogging tool for automated blog entry creation and blog entry upload.

FIGS. 7 and 8 show flow diagrams illustrating example detail of blocks introduced in the flow diagram of FIGS. 6A and 6B.

FIG. 9 shows an example of multimedia blogging, including provisions for both micro-blogging and macro-blogging.

### DETAILED DESCRIPTION

The disclosure describes techniques for providing a blogging tool for automated blog entry creation and automated uploading of the blog entry to a server. The blogging tool may combine multimedia content, organize the content within an appropriate template, and upload a blog entry in a seamless and automated manner. An example illustrating some of the techniques discussed herein—not to be considered a full or comprehensive discussion—may assist the reader.

An image capturing process may obtain a plurality of images according to direction of a user, who may operate an image-capture device. Throughout this document, the term “images” is used to indicate at least still images, e.g., “pictures,” and moving images, e.g., “video.” One or more images may be annotated with metadata, such as location or date of the image. Additionally, one or more image(s) may be annotated with a legend of text, which may be derived from verbal content provided by the user.

A template may be selected in either an automated or user-controlled manner. In one example, a current template is evaluated in an iterative manner, such as after capture of each of the plurality of images. Each evaluation provides an indication of whether a different template, such as from a template library, might provide a better fit to the plurality of images. If indicated, the different template is selected, and becomes the current template. The current template may be assembled to include the plurality of images, the metadata and the text, to thereby create a blog entry.

The blog entry may be uploaded to a server and appended to a blog hosted by the server. In one example, the uploading may be triggered in response to a single command given by the user, such as by operation of a button or by spoken command.

The discussion herein includes several sections. Each section is intended to be non-limiting; more particularly, this entire description is intended to illustrate components which may be utilized to implement and operate an automated blogging tool, but not components which are necessarily required. The discussion begins with a section entitled “Example Automated Blogging Tool Architecture,” which describes one environment that may implement the techniques described herein. This section depicts and describes a high-level architecture as well as example components configured to provide automated blogging. Next, a section entitled “Example Automated Blogging Device User Interface” illustrates and describes aspects that can be used to provide a user interface that provides user control over an automated blogging system and method. A further section, entitled “Example Flow Diagrams” illustrates and describes techniques that may be used to provide an automated blogging tool to combine multimedia content within an appropriate template, and to upload a resultant blog entry in an automated manner. A further section, entitled “Multimedia Blogging Example” illustrates a specific example of multimedia blogging. Finally, the discussion ends with a brief conclusion.

This brief introduction, including section titles and corresponding summaries, is provided for the reader's convenience and is not intended to limit the scope of the claims or any section of this disclosure sections.

### Example Automated Blogging Tool Architecture

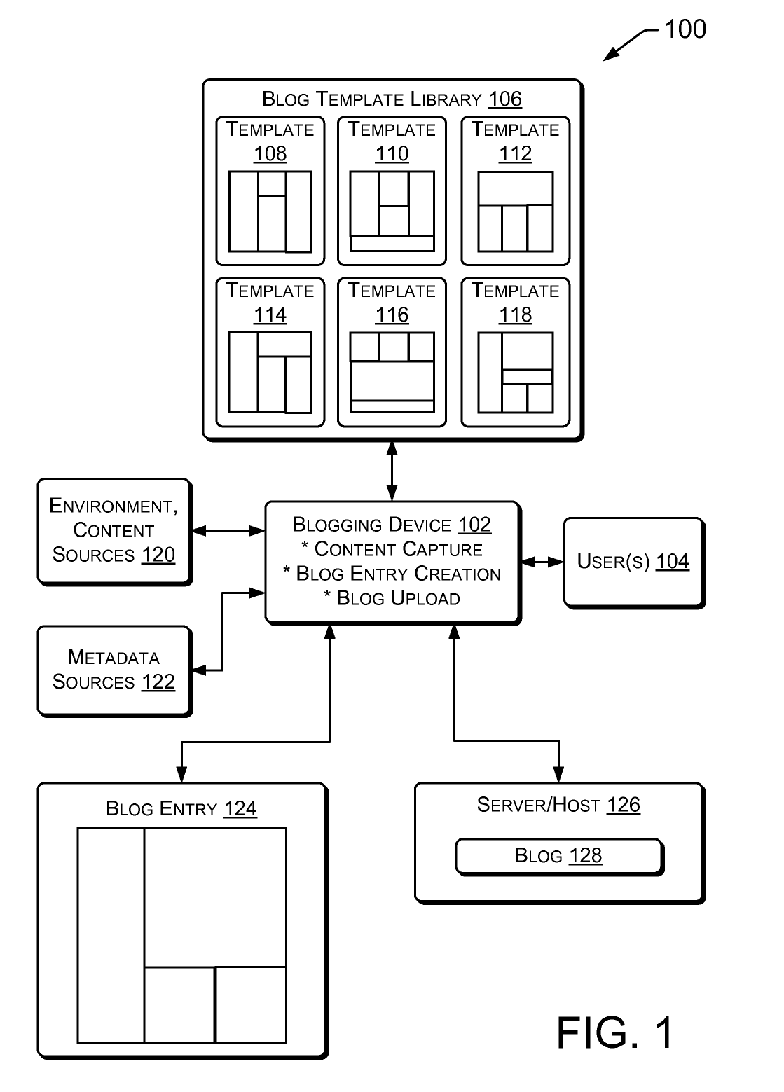

FIG. 1 is a diagram illustrating an example of a functional architecture, configuration or system 100 that provides a blogging tool for automated blog entry creation and upload to a server. Accordingly, the example of FIG. 1 is provided as a specific instance to illustrate more general concepts, and not to indicate required and/or necessary elements.

Referring to FIG. 1, a blogging device, blogging tool or automated blogging tool 102 is configured for operation by a user 104 to capture content, to create a blog entry and to upload the blog entry to be appended to a blog hosted by a server. The blogging tool 102 may be configured to include the functionality of a camera, video camera and/or audio recording device. In one example, the blogging tool 102 may be a “smart phone,” i.e., a cellular phone. The cellular phone may have an “app” (i.e., an application) that may perform and/or direct some or all of the functionality of the automated blogging tool architecture. In the example of FIG. 1, the blogging tool 102 includes the functionality of a camera configured to capture images (e.g., still images or “pictures,” and moving images or “video”) and audio recordings. The blogging tool 102 is additionally configured with hardware and/or software enhancements to enable automated blogging functionality. Thus, the blogging tool 102 has image/video/audio capture capabilities to enable it to obtain and record content for use in the creation of a blog entry. Additionally, the blogging tool 102 is configured to assemble the recorded content into a template, to create a blog entry and to transfer the blog entry to a server hosting an associated blog.

The user 104 controls operation of the blogging tool 102. For example, the user provides commands to the blogging tool, such as to capture an image, to begin and end capture of a video, to assembly a blog entry and/or to upload the blog entry. The blogging tool 102 also communicates to the user 104. For example, the blogging tool 102 provides the user with information and copies of the images captured and available for a blog entry, an indication of a proposed or selected template, and a preview of the blog entry as it is created.

A blog template library 106 may include a plurality of templates. The blog template library 106 may be located on memory internal or external to the blogging tool 102. As an example, the blog template library 106 of FIG. 1 includes example templates 108-118. Each template 108-118 provides a framework to contain content, and to thereby form a blog entry for posting on a blog (e.g., a web log, or website which may chronicle the activities, the life and times, or any other topic that the user 104 chooses to chronicle). Each template provides regions within which an image, a video, text or other content may be located. The templates may be diverse in configuration, in that each template may include regions whose size, shape and arrangement distinguish it from other templates. Accordingly, one template may be more advantageous to contain the content obtained by the user. For example, the number of images possessed by the user and the number of regions in a template may correspond. Also, the sizes of the images and text (i.e., generally, the content of the blog entry), and the order in which the content is advantageously displayed, may indicated a preferred template for a particular blog entry.

The environment 120 provides a source of content for image capture. That is, the world around the user 104 may be photographed, or otherwise recorded, to create content for the blog entry. Thus, the user's home, family, school, vacation, city are all part of the environment 120, and provide a fertile source of content for image capture and for recording.

Additionally, metadata sources 122 may be captured. Metadata sources 122 can include data to associate with images, text or other content. For example, metadata can include day and date, time of day, location, maps showing the location, street-view images of the location or surrounding location. Such metadata may be attached to images captured (such as images of the environment 120).

In some instances, the metadata 122 may separated from the content image with which it is associated. In such an instance, the metadata may be located in a region in the template that is separate from a region in the template occupied by the associated content image. For example, if metadata 122 includes an image of a map or street-view image of a location, then that image may be added to a region that is separate from the region containing the image associated with the metadata.

A template (e.g. template 114), may be configured with content (e.g., images obtained from the blogging tool 102) to form a blog entry 124. The blog entry 124 may be located on memory internal or external to the blogging tool 102. The blog entry 124, once finished and user-approved, may be appended to a blog. The blog may be a website configured as a blog, operated by the user 104 and “hosted” by a server/host 128. The server 128 may be a computer with appropriate network connectivity (e.g., Internet connectivity) configured to serve the blog 130 in response to requests, such as from friends of the user 104 and/or from other users. The blog 130 may be thought of as a list, catalog or inventory of one or more blog entries, generally with the newest blog entry located on top (i.e., in a location seen at the top of a webpage loaded into a viewer's browser).

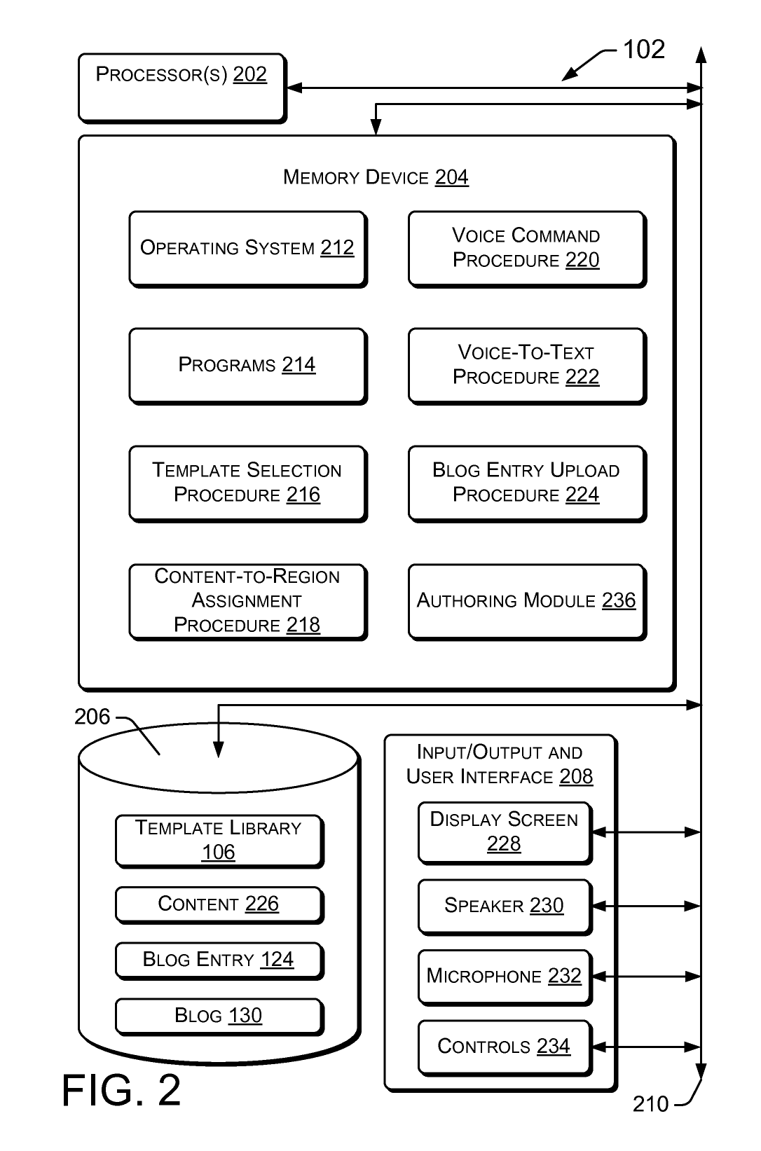

FIG. 2 is a diagram illustrating example techniques for implementation and operation of the blogging device or tool 102. In particular, FIG. 2 shows an example of a configuration, including techniques in hardware, firmware and/or software, which may be utilized by the blogging tool 102 introduced in FIG. 1. In the example of FIG. 2, a processor 202 is in communication with a memory device 204, a disk or memory storage device 206 and an input/output system or user interface 208 over a bus 210 or other network. The processor 202 may include a micro processor, an application specific integrated circuit (ASIC), a memory management unit (MMU), I/O (input/output) devices and/or other information processing devices.

The memory device 204 can be a random access device (RAM) or other device and/or technology, as indicated by the needs of a particular application. The memory device may include or contain an operating system 212 and one or more programs 214 and/or procedures 216-224. Such programs and/or procedures can result in the reading, storing and execution of computer-readable and/or processor-readable statements, which when executed by the processor 202, result in execution of one or more methods, such as methods of performing automated blog creation and upload.

A template selection procedure 216 is configured to select an appropriate template for a blog entry. A template includes a plurality of regions, each region being adapted to contain and position content, such as an image or text. The correct template for a particular blog entry depends on a comparison of each the template's configuration, and factors such as how many content objects there are (in the blog entry), their relative sizes and preferred locations. In the example of FIG. 1, the blog template library 106 includes example templates 108-118, which are representative of templates that could be selected by the template selection procedure 216.

A content-to-region assignment procedure 218 assigns each content file (e.g., an image or text) to specific regions within a template. The assignment may be made using input from the user and from examination of the content itself. For example, if an image file has been characterized (e.g., by the user) as an “initial” image it may be located in an upper region within the template. Content that is “intermediate” and “concluding” may be located in later regions within the template. Content that is “featured” or “larger” may be located in a larger or more prominent region within the template. Accordingly, the content-to-region assignment procedure 216 may utilize input from the user to assign content to specific regions within the template. However, in the absence of specific instructions from a user, the content-to-region assignment procedure 224 logically assigns content to specific regions within a template, based on factors including image sizes, number and other data.

A voice command procedure 220 is configured to recognize voice commands. For example, a voice command may be used to label an image as an “initial image” or a “supplemental image.” A voice command, e.g., “upload blog entry,” may be used to invoke a process to upload a blog entry to a server, where it is appended to a blog hosted by the server. In general, many commands supported by the user interface may be activated by voice, if desired, and recognized by the voice command procedure 220. The technology supporting the voice command procedure may be located on the blogging tool 102 or remotely, as appropriate.

A voice to text procedure 222 may be used as an alternative, or supplement to, a keyboard device (e.g., conventional keyboard or “virtual” touch screen keyboard). The voice to text procedure 222 may be used, for example, to allow the user to input text to accompany an image, that is, to provide a “legend” to the image. The legend may be located adjacent to the image—such as below the image—and explain or enhance the image.

A blog entry upload procedure 224 may be used to provide automated support to the user to upload a blog entry 124 to the server 128 (see FIG. 1). The blog entry upload procedure 224 may be activated by a single button or spoken command in some instances, to provide the user with the most convenient uploading experience. For example, the upload procedure 224 may be configured to handle all of the login “handshaking” and password provisions, and may be configured to transfer the blog entry 124 (see FIG. 1) to the server 128 using any desired file transfer protocol. The blog entry upload procedure 224 may also be configured to append the blog entry to an existing blog, if present.

An authoring tool 236 may be used to coordinate the creation of the blog entry 124. The authoring tool 236 may be separate from, or may include one or more of the template selection procedure 216, the content-to-region assignment procedure 218, the voice command procedure 220, the voice-to-text procedure 222 and the blog entry upload procedure 224.

The storage device 206 may be based any desired technology, such as disk drive and solid state technologies. In the example of FIG. 2, the storage device 206 may include files associated with the template library 106, content 226, a blog entry 124 and a blog 130. The template library 106 may include any number of pre-formed or custom made templates. Each template may include one or more regions into which content (e.g., images or text) may be inserted. Thus, the templates provide a framework for a blog entry, comprising a number of differently shaped and arranged regions, into which images, video, text and other content may be pasted, inserted and/or otherwise associated. The templates may additionally be thought of as data structures, each controlling aspects of data (e.g., content) storage, display and arrangement.

The content 226 may include one or more images, text, video, sound or other content from any source. The sound recordings may be part of a video file, or may be stand-alone files that may be incorporated into a blog entry 124. The content 226 may be referred to, for example, as “images” or “text”; however, the content may alternatively be understood to be data files within a file system, wherein each data file may contains an “image” or “text.”

The blog entry 124 may be fully formed or may be under construction. The blog entry 124 may include a template having one or more regions. The region(s) are associated with, or are available for association with, content. Thus, as content become available, regions of the template are filled. When a blog entry is finalized, it may be appended to the blog 130.

The input/output system or user interface 208 is configured to provide a user 104 (shown in FIG. 1) with information, and to obtain information and direction from the user. The user interface 208 may include techniques, aspects and/or elements implemented in hardware, firmware and/or software, and may be in communication with the processor 202, the operating system 212, programs 214, procedures 216-224 and other elements over the bus 210. The user interface 208 may include a visual display screen or device 228 and one or more audio speakers 230 to provide the user with information. In the event of a touch screen, the screen 228 would also act as an input device. A microphone 232 and one or more controls 234 (e.g., buttons, switches or other control devices) are also in communication with the processor(s) 202, and provide a means for the user to provide direction and content to the processor 202 and memory devices 204, 206.

### Example Automated Blogging Device User Interface

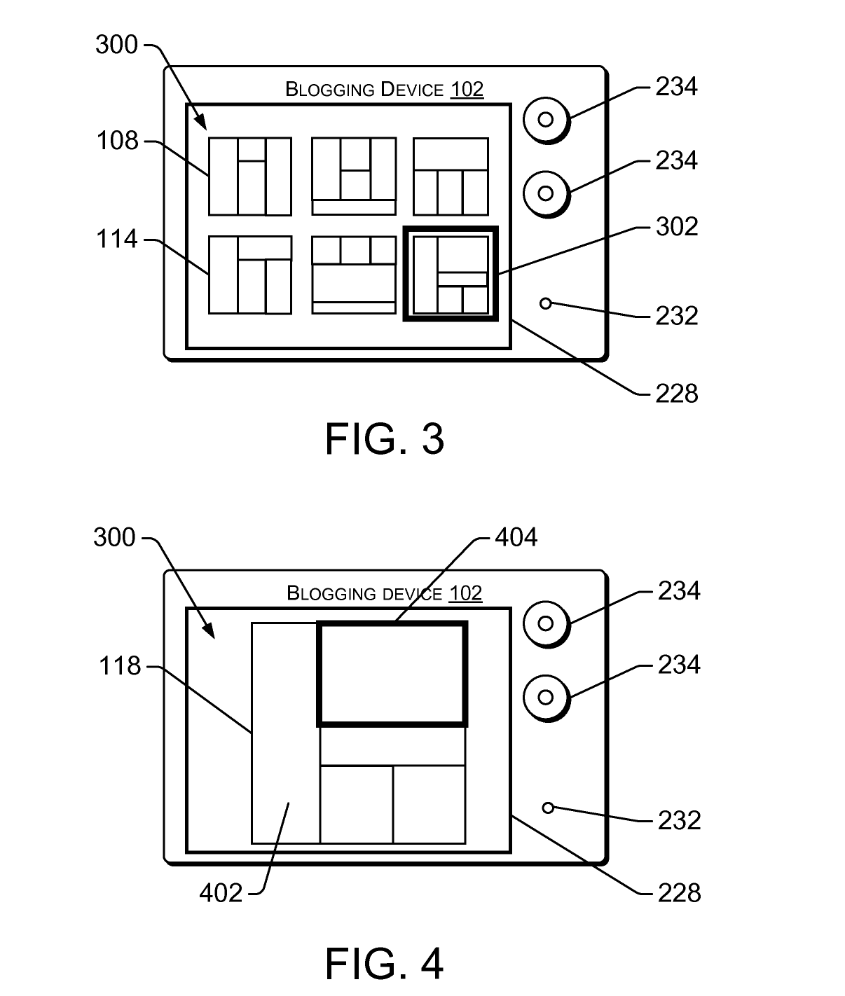

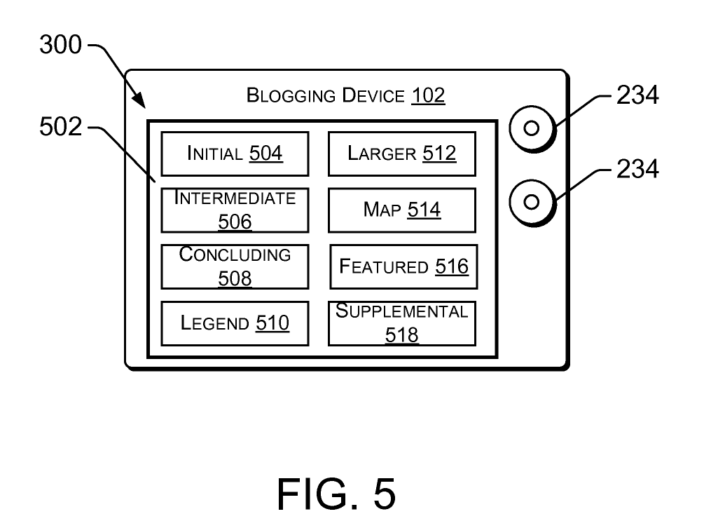

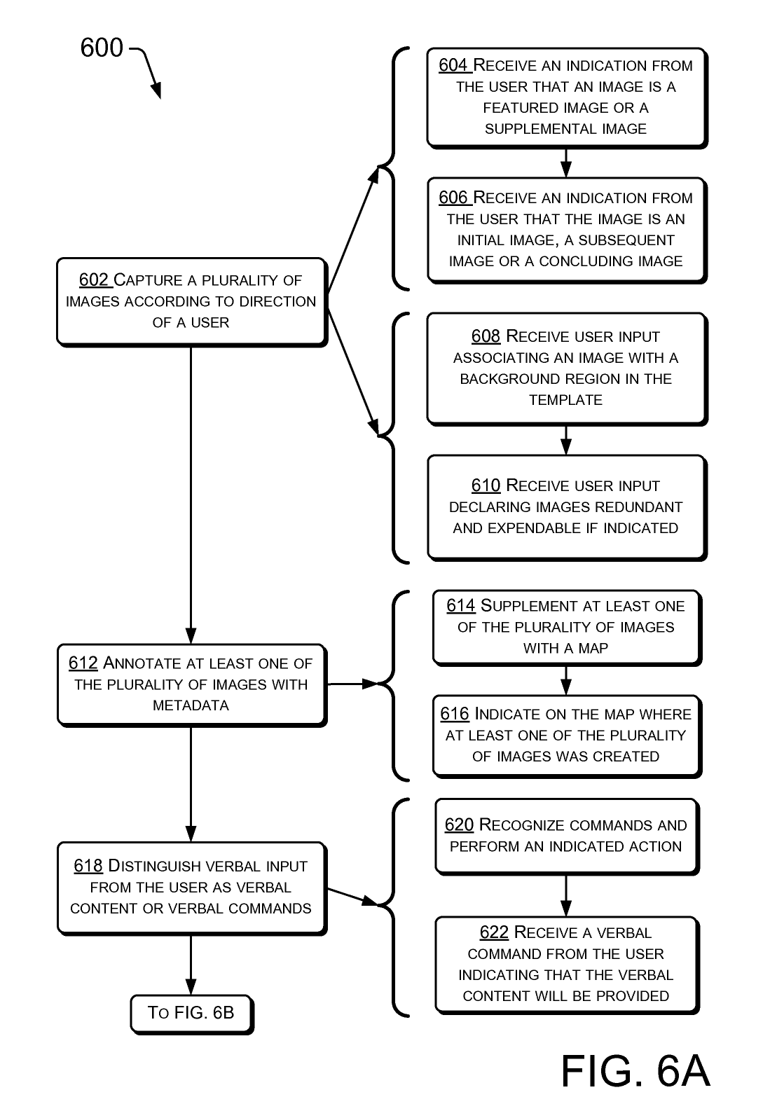

A user interface may be included within, or displayed by, the automated blogging device 102 (FIGS. 1 and 2). The user interface may assist the user to conveniently combine multimedia content into a blog entry and to upload of the blog entry in an automated manner to a server hosting an associated blog. The user interface may include elements such as the input/output and user interface 208 (FIG. 2) and associated screen 228, speaker 230, microphone 232 and controls 234. FIGS. 3 through 5 are diagrams illustrating examples of portions of the user interface 300. FIG. 3 shows an example of how templates may be selected may be selected by user input. FIG. 4 shows how a user may select a particular region within a template, such as for association with a particular image, video, text or other content. FIG. 5 shows an alternative to such user selection of a region, and instead shows how a user may characterize an image to assist an automated function to pair the image with an appropriate region within a template.

FIG. 3 shows an example of the blogging tool 102, illustrating an example of a portion of the user interface 300, and particularly facilitating user selection of templates. In the example of FIG. 3, the user interface 300 includes techniques for input and output. In particular, the user interface may include a display screen 228 optionally having touch-screen functionality, one more manual control devices 234, and a microphone 232 for voice command input or other functionality. In the example of FIG. 3, a number of templates 108-114, etc., are shown on the display screen 228. Operation of one or more of the controls 234 may allow the user to scroll up and down, to reveal more template selections. A template may be indicated by operation of one of the controls 234, resulting application of a highlight 302 of the template. The indicated (highlighted) template may be selected (such as for use in a blog entry) by further operation of one of the controls 234. Alternatively, a template may be selected in an automated manner. Automatic selection of the template may be based on an algorithm providing a desired “fit” between the available content and the selected template.

FIG. 4 shows an example of the blogging tool 102 having an optional potion of the user interface 300 configured to allow the user to select a region within a template to which to associate an image or other content. In particular, a selected template 118 is shown. The selected template may be empty, partly full, or completely full of content. That is, some, all or none of the regions within the template 118 may include images or other content. Conversely, some, all or none of the regions 118 within the template may be blank, and therefore ready for association with an image or other content. In the example of FIG. 4, the template 118 was selected by a user, such as by operation of the controls 234 and highlighting tool 302 of FIG. 3.

The selected template 118 provides five regions 402, etc., within which content may be located. The regions are not all the same size or shape, and are differently located relative to each other, and therefore provide diversity which encourages and supports inclusion of differently sized images, which may be conducive to an attractively laid-out blog entry. One of the five regions has been selected, such as by operation of controls 234 or a touch screen, and is indicated by a highlight 404 of the region. This provides the user with one way in which to isolate the region at highlight 404, and to assign an image to that region. For example, by highlighting the region, and then taking a picture or otherwise capturing content, the user is able to insert content into region at highlight 404 of the template 118.

FIG. 5 shows an example of the blogging tool 102 having an optional portion of the user interface 300 configured to allow the user to characterize content captured by the blogging tool. The characterization may be made according to one or more categories or parameters that may assist an algorithm in associating the content with an appropriate region within a template. To support user input characterizing the content, the image 502 (or other content) may be superimposed by a portion of the user interface 300 including buttons 504-518. The buttons 504-518 are representative of a generalized system of characterizing content to assist in the automated association of content with regions of a template. The buttons 504-518 may be supported by touch screen technology, or by a scrolling and selection technique using buttons 234, or other techniques as desired. The buttons 504-518 allow the user to characterize the content according to one or more categories that will assist an algorithm in associating the content with a region within a template. For example, content-to-region matching procedure 218 (see FIG. 2) uses input from the user and from examination of the content and the template to associate each content file to a region within a template.

Thus, the touch screen buttons 504-508 allow the user to characterize the image 502. Button 504 allows the user to characterize the content as being an “initial image,” which is typically an image that should be located at the top or top left of a template. That is, the user may feel that the image may be closely associated with a beginning of a story that the user is telling with a particular blog entry. Similarly, buttons 506 and 508 allow the user to characterize the content as being an “intermediate” or “concluding” image, indicating that an algorithm or automated procedure should locate the image in a middle or concluding portion of the template. Further, button 510 allows the user to characterize the image 502 as being a “legend,” such as text associated with another image. The legend may be created by operation of a voice-to-text algorithm (e.g., algorithm 222 of FIG. 2) or by operation of a keyboard. Button 512 allows the user to indicate that the content could be characterized as being “larger,” such as a large amount of text or a higher resolution photograph. Such content could be located in a larger region within a template, to avoid loss or resolution and/or text that is too small to read easily. Button 514 allows the user to characterize the content 502 as a map. In this circumstance, the image could be positioned in a location that was considered to be well-suited for a map, such as near an image taken at a location disclosed by the map. Buttons 516 and 518 allow the content to be characterized as “featured” or “supplemental.” Such content would be assigned to more or less prominent regions within a template, respectively. Accordingly, each content element may be assigned to an appropriate region within a template.

### Example Flow Diagrams

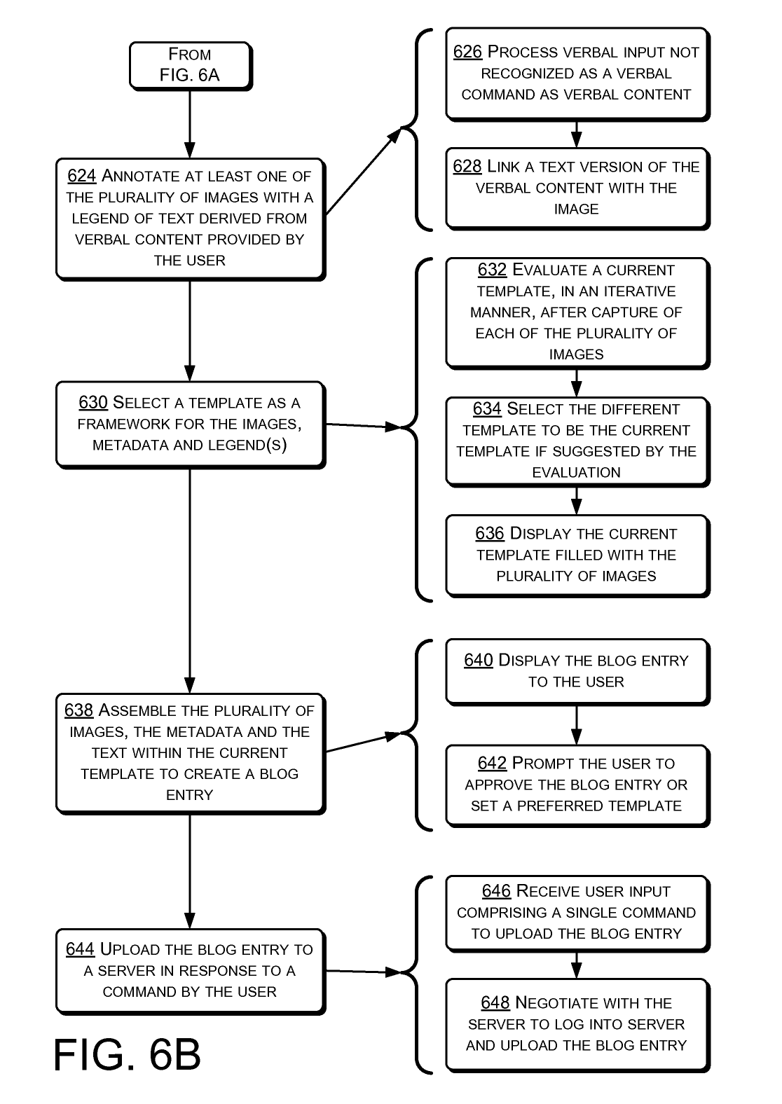

FIG. 6 is a flow diagram illustrating an example process 600 for providing a blogging tool for automated blog entry creation and blog entry upload. The example process of FIG. 6 can be understood in part by reference the configuration of FIGS. 1-5. However, FIG. 6 contains general applicability, and is not limited by other drawing figures and/or prior discussion.

Each process described herein is illustrated as a collection of blocks in a logical flow graph, which represent a sequence of operations that can be implemented in hardware, software, or a combination thereof. In the context of software, the blocks may represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. The above discussion applies equally to other processes described herein.

At operation 602, a plurality of images is captured according to direction of a user. The images may include still images (e.g., “pictures”) or moving images (e.g., “video”). In one example, a user may operate a device such as a camera, video camera and/or voice recorder to capture content. Further, the user may determine desired people, scenes or objects to be included in the content, and may take pictures or video as desired. Accordingly, the user may control the capture of content including images at least as provided by known cameras, video cameras and recording devices. Referring to the example of FIG. 1, the blogging tool 102 may incorporate the functionality of digital cameras having image, video and audio recording capability. Accordingly, the blogging tool 102 may be used to capture images according to the direction of the user.

Operations 604-606 describe alternative and/or supplemental operations to the image capture of operation 602. At operation 604, the user may indicate that the image is a “featured image” or a “supplemental image.” Thus, when capturing images according to operation 602, the user may emphasize the importance of such a captured image by indicating that it is a “featured image,” or the user may somewhat downplay the importance of the image by indicating that it is a “supplemental image.” For example, such information may be added by operation of the user interface of FIG. 5.

By adding this information to the captured image, the image may be more appropriately positioned within the template, in a region befitting its importance relative to other images. For example, the content to region procedure 218 of FIG. 2 may utilize such information. At operation 606, the user may indicate that the image is an “initial image,” a “subsequent image” or a “concluding image.” Thus, the user may indicate something about the chronology of the images in the blog entry, such as by input to a user interface similar to that of FIG. 5. In a particular example, the images may show three brothers, but the images may not have been taken in any particular order. By indicating an “initial image,” the older brother may be the focus of the first image. Similarly, the middle brother may be featured in the “subsequent image” and the younger brother in the “concluding image.” Thus, the user may assume control over the ordering of images within the template of the blog entry.

Operations 608-610 describe additional alternative and/or supplemental operations to the image capture of operation 602. These operations may be performed using an interface similar to that seen in FIG. 5, modified to include the indicated inputs. At operation 604, the user may indicate that the captured image is a background image. Thus, the background image may be appropriately positioned within a template having a background region, e.g., a region that is partially eclipsed by one or more other regions. At operation 610, the user may indicate that an image is redundant. A redundant image may add only marginally to the blog entry, and therefore is expendable if indicated by the number of other images, the size and configuration of the template.

At operation 612, at least one of the plurality of images is annotated with metadata. Referring to the example of FIG. 1, metadata sources 122 may be provided to the blogging tool 102. Metadata may include the time, date, location (e.g., a GPS-derived location or street address), or other information. Metadata can include almost any other information, such as annotations including names, ages or addresses of the individuals within the images. Accordingly, any desired metadata may be included in with one or more of the plurality of images.

Operations 614-616 describe additional alternative and/or supplemental operations to the annotation operation 612. At operation 614, at least one image may be supplemented with a map. The map may provide information about the at least one image, such as the location at which the image was taken and/or captured. The map may be a street view, satellite view, conventional map or other drawing or illustration. The map may be associated with the image by a legend indicating the association, or the map may be located in an inset within the image with which it is associated. At operation 616, the map itself may be annotated, such as to indicate where the image was created.

At operation 618, verbal input from the user is processed, to recognize and distinguish verbal content or verbal commands. Verbal content may include verbal text, such as a legend for an image or other text, such as stand-along regions of text, to be added to the blog entry. Verbal commands may include verbal directions to the automated blogging tool, which indicate aspects of how the user would like a blog entry to be created and/or uploaded to the server. Verbal commands may be recognized and performed by the voice command procedure 222 of FIG. 2, or similar process.

Operations 620-622 describe additional alternative and/or supplemental operations to the distinguishing operation 618. At operation 620, a command is recognized, and the action indicated by the command is performed. For example, at operation 622, the user may issue a verbal command, such as “speech to text.” Such a command may be recognized, such as by the voice command procedure 220 of FIG. 2, which evaluates spoken words, recognizes commands and distinguishes other spoken words, and executes the recognized commands. Once the command is recognized, it may be implemented. For example, following the “speech to text” command, the command would be executed by converting the speech following the command to text, such as by voice to text procedure 222 of FIG. 2.

At operation 624, at least one of the plurality of images is annotated with a legend of text. In one example, the text may be derived from the voice to text procedure 222 of FIG. 2. Alternatively, the text may be entered by means of a keyboard or virtual keyboard (e.g., a keyboard on a touch screen) or other means, as indicated by requirements of a particular application.

Operations 626-628 describe additional alternative and/or supplemental operations to the annotating operation 624. At operation 626, verbal input not recognized as a verbal command may be processed as verbal content. Thus, verbal commands may include keywords, which if not present, allow the verbal input to be processed as verbal content. Verbal content may include a text legend to annotate an image, or a text region that is part of the blog entry. At operation 628, a text version of the user's verbal content may be linked to an image. For example, the metadata of the image may be annotated to include the text. Alternatively, text may be linked to a region within a template of a blog entry.

At operation 630, a template is selected as a framework for the images, text legends associated with images, text, metadata and other content. The template may also be selected for adaptation to contain data associated with audio recordings, including voice and non-voice sounds. The template may be selected initially, before capture of any content, and appropriate kinds and amounts of content captured to fill the template. Alternatively, the template may be selected at a later time, after some or all of the content has been selected, when the nature of the required template, including numbers and relative sizes of the included regions, is known.

Operations 632-634 describe additional alternative and/or supplemental operations to the template selection operation 630. At operation 632, a current template may be evaluated in an iterative manner after capture of each of a plurality of images for inclusion within a blog entry. Accordingly, the process may be automated, and is in contrast to the user-selection described with respect to FIG. 3. The evaluation process may be repeated iteratively to determine if the current template is still preferred. Iterations may be appropriate after capture of an additional image(s), text or other content, which may or may not fit appropriately within the current template. At operation 634, a different template may be selected to become the current template if suggested by the evaluation. Thus, the changing number and characteristics of the images and other content captured by the blogging tool may indicate that the template should be replaced with a template that is more compatible with the available content. At operation 636, the current template may be displayed with the currently available images and other content elements. This allows the user to see the characteristics of the blog entry as it is developed.

Thus, at operation 638, the plurality of images, the metadata and the text is assembled into the current template to create a blog entry. The software data structures and/or objects that are associated with the creation of the blog entry are similarly created. Operations 640-642 describe additional alternative and/or supplemental operations to the assembly operation 638. At operation 640, the blog entry may be displayed to the user, and at operation 642 the user may be prompted to approve the blog entry. Alternatively, the user may substitute a preferred template and/or alter the content associated with the current template.

The above operations may be repeated as indicated or required, in an iterative manner to create the blog entry.

At operation 644, the blog entry may be uploaded to a server in response to receipt of a command given by the user. The command may be a verbal or manual interaction with a user interface, such as the user interface seen in FIGS. 3-5. Operations 646-648 describe additional alternative and/or supplemental operations to the uploading operation 644. At operation 646, user input may be received by the blogging tool, such as a single command, to upload the blog entry. If indicated by circumstances, a more complex series of commands may be utilized. At operation 648, in response to the command, the blogging tool negotiates with a server to log into the server and to upload the blog entry. Typically, the blog entry is appended to an existing blog. If the blog entry is an initial entry, it may be appended to a null blog or the equivalent.

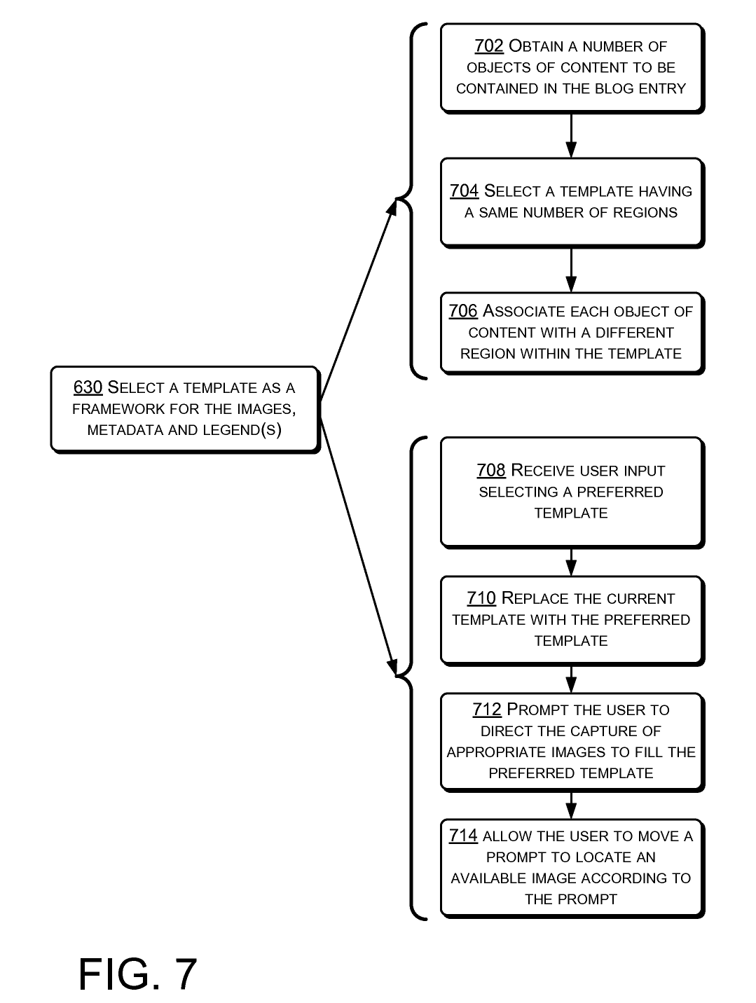

FIG. 7 is flow diagram illustrating additional examples of the operation seen at block 630. Accordingly, while example operations have already been disclosed that select templates for use in the creation of a blog entry, additional and/or alternative examples are disclosed in FIG. 7. Operations 702-706 may be performed in an automated manner, such as by template selection procedure 216. At operation 702, a number of objects of content to be contained in a blog entry is obtained. The content may include images, text and other content, such as maps or other metadata. At operation 704, a template having a same number of regions is selected. Alternatively, a template having a number of regions that is equal to a predicted or projected number of objects of content may be selected. At operation 706, each object of content may then be associated with different region within the selected template.

A further example of selecting a template as a framework for the content (e.g., images, metadata and text) is seen at blocks 708-714. At operation 708, user input selecting a preferred template may be received by the blogging tool. At operation 710, the current template may be replaced with the user-selected or preferred template in response to the user input. The user interface of FIG. 3 provides an example of user selection of a template. At operation 712, the user may be prompted to direct the capture of appropriate images to fill the preferred template. That is, the user will be prompted to operate an image capture device to obtain the appropriate images to fill regions within the user-selected preferred template. At operation 714, the user is allowed to move a prompt to locate an available image within the template. Referring to FIG. 4, the highlighted region 404 prompts the user to obtain an image for that region. Alternatively, the highlighted region 404 indicates a destination region for a captured image. Thus, the user can select a region into which an image will be positioned, or obtain an image for an indicated region. In both cases, a region and an image are associated.

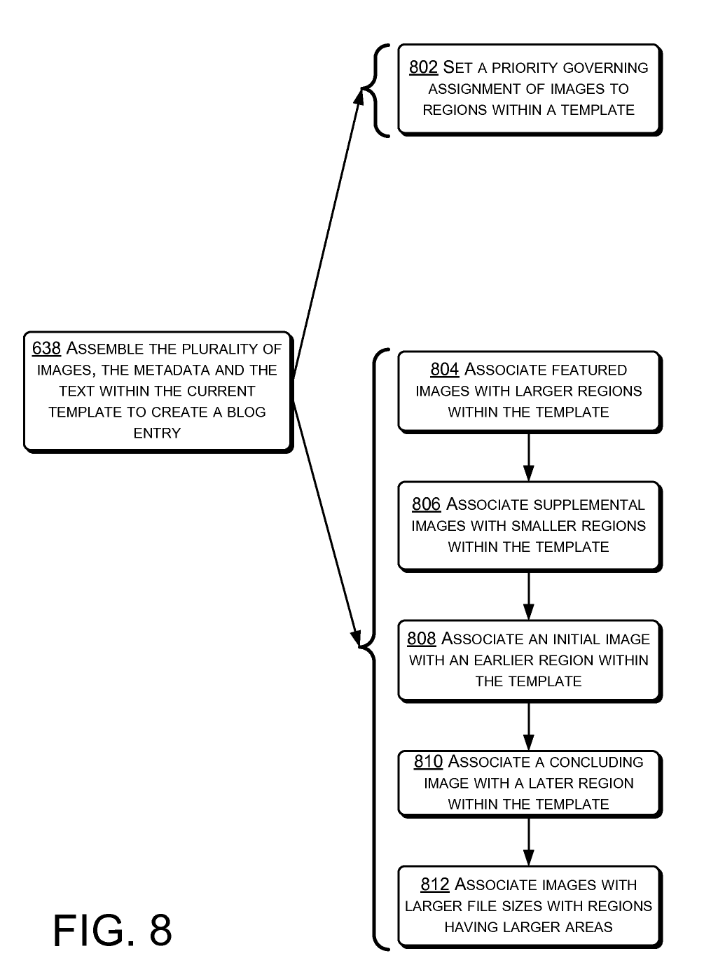

FIG. 8 is flow diagram illustrating additional examples of the operation seen at block 638. Accordingly, while example operations have already been disclosed that assemble content, including a plurality of images, metadata and text, into a template to create blog entry, additional and/or alternative examples are disclosed in FIG. 8. At operation 802, a priority may be set to govern assignment of images to regions within a template. The priority may be compound, i.e., it may have a number of parts or “rules,” as seen in the example of blocks 804-812. These “rules” may be prioritized according to input from the user and/or design of the blogging tool.

In one example, the user interface of FIG. 5, or a variation thereof, can be used to gather input useable by operations 804-812. At operation 804, images indicated by the user to be “featured images” are associated with larger regions within the template. At operation 806, images indicated by the user to be “supplemental images” are associated with smaller regions within the template. At operation 808, image indicated by the user to be “an initial image” is associated with an earlier region within the template, such as a region that is in the upper left of the template. At operation 810, image indicated by the user to be “a concluding image” is associated with a later region within the template, such as a region that is in the lower right of the template. At operation 812, images with larger file sizes are associated with regions having larger areas. Accordingly, the resolution of images within each region of the template is more consistent than would otherwise be the case.

### Multimedia Blogging Example

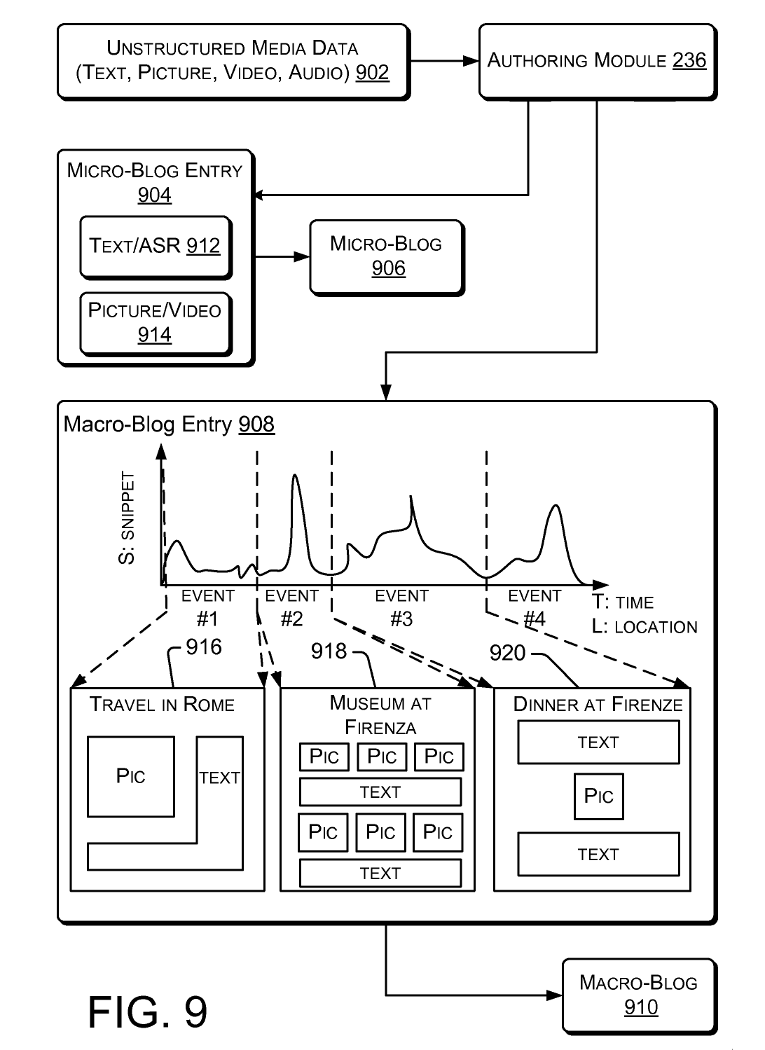

FIG. 9 shows an example of multimedia blogging, including provisions for both micro-blogging and macro-blogging. Such blogging may include blog entries broadcast to one or more friends or family, blog entries posted to a server-hosted blog, or blog entries sent to social networking websites such as Live, Facebook, MySpace, etc. The blog entries may be created from content, including unstructured media data 902. Unstructured media data 902 can include any media and/or multimedia recordings, images or associated data files. The data may be considered “unstructured” because it may not be assembled into a format appropriate for a micro-blog or macro-blog entry. In particular, unstructured data may lack templates or other structures which formats data into a blog entry, or may lack the associations between different data objects or files that add value to a blog entry. Examples of the unstructured media data 902 may include: recorded verbal passages; text or rich text (e.g., text including formatting data, font data and/or metadata); other audio, voice, music and/or mixed-input recordings; video and/or audio/video recordings; and other media and multimedia files and information. Audio recordings may have been captured using a microphone embedded in a blogging device 102 (e.g., see FIG. 1). Similarly, images, including pictures and/or video, may have been recorded through a camera, cellular telephone camera or other image-capture component in any device (e.g., the blogging device 102 of FIG. 1). Each media object, file or snippet in the unstructured media data 902 may be associated with, or annotated by, content or metadata describing aspects such as GPS location, a timestamp recording date and time, accelerometer parameters, and other input, as indicated by the particular data element and as indicated by hardware and/or software architecture of a blogging system.

The unstructured media data 902 may be used as input by an authoring module 236 or a blogging device (e.g., the blogging device 102 of FIGS. 1 and 2). In particular, the authoring module 236 may be contained within a blogging device 102 (see FIG. 2), which may be in the form of a cellular telephone. In such an implementation, the authoring module 236 may be an “app” or application running on a cellular or smart phone. The authoring application 236 may provide the author (e.g., a person operating the smart phone) with a user interface allowing choice between creating an entry to a micro-blog 906 or a macro-blog 910. Alternatively, the distinction between micro-blog and macro-blog may be set by a rule or definition, such as if the captured data represents a period of time less than a threshold Tₜᵢₘₑ, or the data size of the entry is less than a threshold T_{size}, then the blog entry is a micro-blog entry, and otherwise the blog entry is a macro-blog entry. Accordingly, the micro-blog entry may comprises a “tweet”-like blog entry, while the macro-blog may include a larger blog entry, typically having more than one data object and some structuring format, such as a template.

A micro-blog entry 904 may be appended to an existing micro blog 906, sent directly to an audience (e.g., the family and friends of the author), and/or may be posted on a social networking website. In the event that the micro-blog entry 904 is appended to an existing micro-blog 906, it may be downloaded by members of the audience at their convenience. In the event that the micro-blog entry 904 is sent directly to the audience, it may appear on their cellular phones and/or computers or other devices in an automated fashion.

The micro-blog entry 904 may include text and/or automated speech recognition (ASR) 912, and/or a picture/video or other content 914. Accordingly, the micro-blog entry 904 may provide the audience with a limited multimedia experience.

The macro-blog entry 908 may include more content or content diversity than the micro-blog entry 904. Accordingly, the macro-blog is a well-developed content-rich type of blog that is typically associated with blogging. Blog entry 908 may be constructed by segmenting the unstructured media content 902 based on timestamp, location or any other desired parameter(s). Accordingly, one or more events may be created. Four such events are seen within the macro-blog entry 908 of FIG. 9 (e.g., Event #1 through Event #4). The events are organized according to time and location about one axis, and content—e.g., input from audio, video and text (i.e., the “snippets”)—on the other axis. Each event may include one or more “snippets” of data, such as images, recordings, video, text, etc. The data within each event is associated by the time and/or location of the data.

Each event may be associated with a template, which contains that data. For example, templates 916-920 are associated with Event #1 through Event #3, respectively. Each template 916-920 includes content that was grouped together due to closeness in time and/or location. Accordingly, a template (e.g., one of templates 916-920) comprising one or more data files, objects or “snippets” of content, may be created for each event.

Because data collected at a particular location (e.g., a GPS-determined location) or period of time tends to be related, it can reliably be grouped as an “event.” Such a grouping—based on time and/or location—can thereby be used to create one or more events, such as the four events seen in FIG. 9. Each event can then be characterized, either by operation of an automated algorithm or by user input. The characterization may include activities such as “travel,” “family dinner,” “sporting event,” etc. Because the location of data capture may be known, it may be possible, for example, to associate the data with a specific sports stadium, restaurant or family home. Such an association may indicated that a particular template(s) should be selected from a template library. For example, one or more of the templates 108-116 of the template library 106 (see FIG. 1) may be associated with a particular event or activity. To facilitate this association, the template library 102 may be categorized into templates for convenient association with particular events, such as sporting event, travel, entertainment or family get-togethers. Accordingly, such a template(s) could automatically be suggested to the user. Alternatively, the user could select a preferred template. By either method, the template may be selected to appropriately position the data files and/or objects included in the unstructured data 902. Also, because some knowledge of the user's situation is known (e.g., the user's location) is may be possible to automatically generate suggested titles or image captions and propose them to the user. As the template is filled, the macro-blog entry 908 is created. The blog entry 908 may then be posted on a server-hosted blog 910.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more computer-readable media storing computer-executable instructions that, when executed, cause one or more processors to perform acts comprising:
annotating at least one of a plurality of images with metadata, each of the plurality of images having been captured according to direction of a user;
annotating at least one of the plurality of images with text derived from verbal content provided by a user;
selecting a template, the selecting comprising:
evaluating a current template, in an iterative manner after capture of each of the plurality of images, for an indication that a different template would be a better fit to the plurality of images; and
selecting the different template to be the current template if suggested by the indication;
assembling the plurality of images, the metadata and the text within the current template to create a blog entry; and
uploading the blog entry to a server in response to receipt of a command from the user.

2. One or more computer-readable media as recited in claim 1, wherein annotating at least one of the plurality of images with metadata comprises annotating images comprising pictures and video, and wherein the annotations comprise a timestamp and a GPS-derived location.

3. One or more computer-readable media as recited in claim 1, wherein selecting a template additionally comprises:
selecting a template adapted to include data associated with audio recordings, including voice and non-voice sound.

4. One or more computer-readable media as recited in claim 1, wherein annotating at least one of the plurality of images with the text derived from verbal content provided by the user comprises:
receiving a verbal command from the user indicating that the verbal content will be provided; and
linking a text version of the verbal content with the image.

5. One or more computer-readable media as recited in claim 1, wherein selecting the template additionally comprises:
determining a number of objects of content to be contained in the blog entry;
selecting a template having a same number of regions as the number of objects; and
associating each object of content with a different one of the regions.

6. One or more computer-readable media as recited in claim 1, wherein selecting the template additionally comprises:
receiving user input selecting a preferred template;
replacing the current template with the preferred template; and
prompting the user to direct the capture of appropriate images to fill the preferred template.

7. One or more computer-readable media as recited in claim 1, wherein assembling the images, metadata and text within the current template comprises:
setting a priority governing assignment of images to regions within a template; and
according to the set priority:
associating featured images with larger regions within the template;
associating supplemental images with smaller regions within the template;
associating an initial image with an earlier region within the template;
associating a concluding image with a later region within the template; and
associating images with larger file sizes with regions having larger areas.

8. One or more computer-readable media as recited in claim 1, wherein assembling the images, metadata and text within the template to create the blog entry comprises:
displaying the blog entry to the user; and
prompting the user to approve the blog entry or set a preferred template.

9. One or more computer-readable media as recited in claim 1, wherein uploading the blog entry comprises:
receiving user input comprising a single command to upload the blog entry; and
negotiating with the server to log into an account controlled by the user and to transfer data of the blog entry.

10. One or more computer-readable media as recited in claim 1, additionally comprising distinguishing verbal input from the user as verbal content or verbal commands, wherein the distinguishing comprises:
recognizing commands and performing an indicated action; and
processing verbal input not recognized as a verbal command as verbal content.

11. One or more computer-readable media storing computer-executable instructions that, when executed, cause one or more processors to perform acts comprising:
capturing a plurality of images according to direction of a user, the capturing comprising:
receiving user input effective to associate an image with earlier or later regions within a template; and
receiving user input effective to associate an image with a prominent region or a supporting region in the template;
annotating at least one of the plurality of images with a legend of text derived from the user;
selecting the template, the selecting comprising:
receiving user input selecting a preferred template;
prompting the user to direct the capture of appropriate images to fill the preferred template; and
allowing the user to move a prompt to locate an available image according to the prompt;
assembling the plurality of images and the legend of text within the template to create a blog entry; and
uploading the blog entry to a server in response to a command by the user.

12. One or more computer-readable media as recited in claim 11, wherein capturing the plurality of images according to direction of the user additionally comprises:
receiving user input effective to associate one of the plurality of images with a background region in the template; and
receiving user input effective to declare one of the plurality of images as redundant and expendable if indicated by considerations of fit within the template.

13. One or more computer-readable media as recited in claim 11, wherein selecting the template additionally comprises:
determining a number of objects of content to be contained in the blog entry;
selecting a template having a same number of regions as the number of objects; and
suggesting the template to the user.

14. One or more computer-readable media as recited in claim 11, wherein selecting the template additionally comprises:
evaluating the template, in an iterative manner after capture of each of the plurality of images, for an indication that a different template would be a better fit to the plurality of images; and
suggesting the different template to the user by displaying the different template filled with the plurality of images.

15. One or more computer-readable media as recited in claim 11, wherein assembling the plurality of images and the legend of text within the template to create the blog entry comprises:
displaying the blog entry to the user; and
prompting the user to approve the blog entry or set a preferred template.

16. A method, comprising:
storing, in a memory communicatively coupled to a processor, computer-executable instructions for performing the method;
executing the instructions on the processor;
according to the instructions being executed:
capturing a plurality of images, comprising pictures and video, according to direction of a user;
annotating at least one of the plurality of images with metadata;
annotating at least one of the plurality of images with text derived from verbal content provided by the user;
selecting a template, the selecting comprising:
evaluating a current template, in an iterative manner after capture of each of the plurality of images, for an indication that a different template would be a better fit to the plurality of images;
selecting the different template, if indicated, to become the current template; and
displaying the current template filled with the plurality of images;
receiving user input, if present, indicating selection of a preferred template to replace the current template, the selection of the preferred template comprising:
receiving input indicating the preferred template from among a plurality of templates within a template library;
prompting the user to direct the capture of appropriate images to fill the preferred template; and
allowing the user to move a prompt to locate an available image in a preferred location;
assembling the plurality of images, the metadata and the text within the preferred template to create a blog entry; and
uploading the blog entry to a server in response to a command by the User.

17. The method of claim 16, wherein capturing the plurality of images according to direction of the user comprises:
receiving an indication that an image is a featured image or a supplemental image; and
receiving an indication that the image is an initial image, a subsequent image or a concluding image.

18. The method of claim 16, wherein annotating at least one of the plurality of images with metadata comprises:
supplementing at least one of the plurality of images with a map; and
indicating on the map where the at least one of the plurality of images was created.

19. The method of claim 16, wherein annotating at least one of the plurality of images with text comprises:
receiving a command from the user indicating that verbal input is associated with an image; and
linking a text version of the verbal input with the image.

20. The method of claim 16, wherein selecting the template additionally comprises:
determining a number of objects of content to be contained in the blog entry;
selecting a template having a same number of regions as the number of objects; and
suggesting the template to the user.
